(19) United States
(12) Patent Application Publication
(10) Pub. No.: US 2022/0033737 A1
(43) Pub. Date: Feb. 3, 2022

(54) COMPOSITIONS FOR MEDICAL INSTRUMENT CLEANING

(71) Applicant: DANISCO US INC, Palo Alto, CA (US)

(72) Inventors: Arjen HOEKSTRA, Oegstgeest (NL); Michael STONER, Palo Alto, CA (US); Zhenfeng ZHAO, Palo Alto, CA (US)

(21) Appl. No.: 17/276,303

(22) PCT Filed: Sep. 17, 2019
(86) PCT No.: PCT/US2019/051464

§ 371 Date: Mar. 15, 2021

Related U.S. Application Data
(60) Provisional application No. 62/737,291, filed on Sep. 27, 2018.

(51) Int. Cl. C11D 3/386; C11D 1/72; C11D 3/43; C11D 11/00

(52) U.S. Cl. CPC C11D 3/38618; C11D 1/72; C11D 11/0023; C11D 3/38663; C11D 3/43; C11D 3/38627

(57) ABSTRACT

Disclosed herein are compositions comprising a nonionic surfactant and one or more inherently stable subtilisin, and methods related to the use of such compositions for the cleaning of medical and dental instruments.

### CROSS-REFERENCE TO RELATED APPLICATION

This application claims priority to U.S. Provisional Application No. 62/737291, filed Sep. 27, 2018, which is hereby incorporated by reference in its entirety.

The present disclosure relates to compositions and methods for medical and dental instrument cleaning.

### BACKGROUND

In the health care industry, medical instruments must be thoroughly cleaned and sanitized before being reused. Cleaning processes include multiple steps which may be automated or manual. The instruments may be heavily soiled with biological soils, in particular protein based soils. Highly alkaline detergents used for cleaning medical instruments are known to be corrosive which is why alternative enzymatic detergents have been developed that can operate at a milder pH.

Usually, these detergents comprise protease, preferably a subtilisin, to remove protein based soils effectively, and a protease stabilizer. Protease stabilizers are normally used to inhibit protease activity during storage of protease containing liquid detergents, where upon aqueous dilution, the stabilizer is released from the protease. A disadvantage of using a protease stabilizer is that it adds cost in use without contributing to the cleaning performance.

### SUMMARY

One embodiment provides a medical or dental instrument detergent composition comprising between about 1% to 15% by weight of a nonionic surfactant, between about 250 ppm and about 10000 ppm of an inherently stable subtilisin variant where the composition does not comprise a substantial amount of a protease stabilizer.

In another embodiment, the disclosure provides a method for cleaning a medical or dental instrument comprising, contacting the medical or dental instrument in a detergent for medical or dental instrument cleaning comprising between about 1% to 15% by weight of a nonionic surfactant; between about 250 ppm and about 10000 ppm of an inherently stable subtilisin variant; where the composition does not comprise a substantial amount of a protease stabilizer, allowing the instrument to be contacted for a period of time sufficient to reduce or remove soils on the instrument, and optionally rinsing the instrument.

### DESCRIPTION

The present disclosure provides compositions (e.g. detergent compositions) and methods using such compositions for medical and dental instrument cleaning. The compositions generally employ a nonionic surfactant and an inherently stable subtilisin variant, and the composition further does not comprise a substantial amount of a protease stabilizer, such as a protease inhibitor, peptide aldehyde, organoboron compound, or a boronic acid derivative. The compositions also optionally comprise additional components of a medical or dental instrument cleaning detergent, such as one or more organic solvents.

Prior to describing embodiments of present compositions and methods, the following terms are defined.

Unless defined otherwise herein, all technical and scientific terms used herein have the same meaning as commonly understood by one of ordinary skill in the art to which this invention pertains. Although any methods and materials similar or equivalent to those described herein find use in the practice of the present invention, the preferred methods and materials are described herein. Accordingly, the terms defined immediately below are more fully described by reference to the specification as a whole. Also, as used herein, the singular terms “a,” “an,” and “the” include the plural reference unless the context clearly indicates otherwise. It is to be understood that this invention is not limited to the particular methodology, protocols, and reagents described, as these may vary, depending upon the context they are used by those of skill in the art.

It is intended that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

### Compositions

In one embodiment, the disclosure provides compositions (e.g. detergent compositions) for use in medical or dental instrument cleaning. The compositions generally comprise a nonionic surfactant, and an inherently stable subtilisin variant. The compositions provided herein further comprise no substantial amount of an enzyme stabilizer. The compositions may also optionally comprise one or more additional components of a medical or dental instrument cleaning composition, such as an organic solvent.

In one embodiment, the composition comprises between about 1% to about 15% by weight of the total composition of a nonionic surfactant, between about 0.5% to about 15% by weight of the total composition of an inherently stable subtilisin variant and substantially no protease stabilizer.

In another embodiment, the composition comprises between about 1% to about 15% by weight of the total composition of a nonionic surfactant, between about 250 to about 10000 ppm of an inherently stable subtilisin variant and substantially no protease stabilizer.

Any nonionic surfactant can be used in the compositions provided herein. Examples of nonionic surfactants that find use in the compositions and methods provided herein include those in Nonionic Surfactants, ed. Nico M. van Os, vol. 72 of the Surfactant Science Series, CRC Press, New York, 1997. In some embodiments, the nonionic surfactant for use in the compositions and methods provided herein are alcohol ethoxylate surfactants. In some embodiments, the nonionic surfactant is a C₆ to C₂₀ alcohol ethoxylate, or a C₁₂ to C₁₄ alcohol ethoxylate.

In one embodiment, the composition comprises between about 1% to about 15%, between about 0.5% to about 15%, or between about 1% to about 10%, or between 2% to about 10% by weight of the total composition of a nonionic surfactant.

In some embodiments, the compositions provided herein also contain a solvent. In some embodiments, the compositions contain between about 10% to about 40%, by weight of the total composition, of one or more surfactants. In another embodiment, the compositions contain between about 15% and about 30% by weight of the total composition, or one or more solvents.

In some embodiments, the one or more solvents used in the compositions provided herein include organic solvents such as, alcohols and/or glycols, preferably ethanol and/or propylene glycol. In one embodiment, the composition contains propylene glycol, such as a mono propylene glycol. Additional solvents include those described in WO2011156297. In one embodiment, the compositions contain a mixture of propylene glycol (e.g. mono propylene glycol) and glycerol as the solvent in the composition.

The compositions provided herein comprise any inherently stable subtilisin, preferably any inherently stable subtilisin variant. An inherently stable subtilisin enzyme is any subtilisin that has been engineered for improved stability such that it requires no protease stabilizer, or uses a reduced amount of a protease stabilizer, to stabilize the subtilisin in a detergent composition.

Inherently stable subtilisins that find use in the compositions and methods provided herein include those described in WO2017210295(e.g. SQCBV35 or SQCBV419), WO2016203064 (e.g. SEQ ID NO: 21), and in U.S. Provisional Application No. 62/591,976, filed Nov. 29, 2017.

In other embodiments, the composition described herein comprises one or more inherently stable subtilisin variant and one or more additional enzyme. The one or more additional enzyme is selected from acyl transferases, alpha-amylases, beta-amylases, alpha-galactosidases, arabinosidases, aryl esterases, beta-galactosidases, carrageenases, catalases, cellobiohydrolases, cellulases, chondroitinases, cutinases, endo-beta-1, 4-glucanases, endo-beta-mannanases, esterases, exo-mannanases, galactanases, glucoamylases, hemicellulases, hyaluronidases, keratinases, laccases, lactases, ligninases, lipases, lipoxygenases, mannanases, metalloproteases, nucleases (e.g. deoxyribonucleases), oxidases, oxidoreductases, pectate lyases, pectin acetyl esterases, pectinases, pentosanases, peroxidases, phenoloxidases, phosphatases, phospholipases, phytases, polygalacturonases, polyesterases, additional proteases, pullulanases, reductases, rhamnogalacturonases, beta-glucanases, tannases, transglutaminases, xylan acetyl-esterases, xylanases, xyloglucanases, xylosidases, and any combination or mixture thereof. Some embodiments are directed to a combination of enzymes (i.e., a “cocktail”) comprising conventional enzymes like amylase, lipase, cutinase, mannanase and/or cellulase in conjunction with one or more inherently stable subtilisin variant and/or one or more additional protease.

In another embodiment, one or more composition described herein comprises one or more inherently stable subtilisin variant and one or more additional protease. In one embodiment, the additional protease is a serine protease. In another embodiment, the additional protease is an alkaline microbial protease or a trypsin-like protease. Suitable additional proteases include those of animal, vegetable or microbial origin. In some embodiments, the additional protease is a microbial protease. In other embodiments, the additional protease is a chemically or genetically modified mutant. In another embodiment, the additional protease is a metalloprotease, a fungal subtilisin, an alkaline microbial protease or a trypsin-like protease. Exemplary alkaline proteases include subtilisins derived from, for example, Bacillus (e.g., subtilisin, lentus, amyloliquefaciens, subtilisin Carlsberg, subtilisin 309, subtilisin 147 and subtilisin 168). Exemplary additional proteases include but are not limited to those described in WO92/21760, WO95/23221, WO2008/010925, WO09/149200, WO09/149144, WO09/149145, WO 10/056640, WO10/056653, WO2010/0566356, WO11/072099, WO2011/13022, WO11/140364, WO 12/151534, WO2015/038792, WO2015/089447, WO2015/089441, US Publ. No. 2008/0090747, U.S. Pat. Nos. 5,801,039, 5,340,735, 5,500,364, 5,855,625, RE 34,606, 5,955,340, 5,700,676 6,312,936, 6,482,628, 8,530,219, U.S. Provisional Appl Nos. 62/180673 and 62/161077, and PCT Appl Nos. PCT/US2015/021813, PCT/US2015/055900, PCT/US2015/057497, PCT/US2015/057492, PCT/US2015/057512, PCT/US2015/057526, PCT/US2015/057520, PCT/US2015/057502, PCT/US2016/022282, and PCT/US16/32514, as well as metalloproteases described in WO1999014341, WO1999033960, WO1999014342, WO1999034003, WO2007044993, WO2009058303, WO 2009058661, WO2014071410, WO2014194032, WO2014194034, WO 2014194054, and WO 2014/194117. Exemplary additional proteases include, but are not limited to trypsin (e.g., of porcine or bovine origin) and the Fusarium protease described in WO89/06270. Exemplary commercial proteases include, but are not limited to MAXATASE®, MAXACAL™, MAXAPEM™, OPTICLEAN®, OPTIMASE®, PROPERASE®, PURAFECT®, PURAFECT® OXP, PURAMAX™, EXCELLASE™, PREFERENZ™ proteases (e.g. P100, P110, P280), EFFECTENZ™ proteases (e.g. P1000, P1050, P2000), EXCELLENZ™ proteases (e.g. P1000), ULTIMASE®, and PURAFAST™ (DuPont); ALCALASE®, BLAZE®, BLAZE® and BLAZE® variants, EVITY®, BLAZE® EVITY®16L, CORONASE®, SAVINASE®, SAVINASE® ULTRA, SAVINASE® EVITY®, SAVINASE® EVERIS®, PRIMASE®, DURAZYM™, POLARZYME®, OVOZYME®, KANNASE®, LIQUANASE®, LIQUANASE EVERIS®, NEUTRASE®, RELASE®, PROGRESS UNO®, and ESPERASE® (Novozymes); BLAP™ and BLAP™ variants (Henkel); KAP (B. alkalophilus subtilisin (Kao)); and BIOTOUCH® (AB Enzymes). Exemplary metalloproteases include nprE, the recombinant form of neutral metalloprotease expressed in B. subtilis (See e.g., WO 07/044993), and PMN, the purified neutral metalloprotease from B. amyloliquefaciens.

Another embodiment is directed to a composition comprising one or more inherently stable subtilisin variant and one or more lipase. In some embodiments, the composition comprises from about 0.00001% to about 10%, about 0.0001% to about 10%, about 0.001% to about 5%, about 0.001% to about 2%, or about 0.005% to about 0.5% lipase by weight composition. In other embodiments, the composition comprises from about 50 ppm to 1500 ppm, or between 150 ppm to about 1200 ppm of lipase in the composition. An exemplary lipase can be a chemically or genetically modified mutant. Exemplary lipases include, but are not limited to, e.g., those of bacterial or fungal origin, such as, e.g., H. lanuginosa lipase (see, e.g., EP 258068 and EP 305216), T. lanuginosus lipase (see, e.g., WO 2014/059360 and WO2015/010009), Rhizomucor miehei lipase (see, e.g., EP 238023), Candida lipase, such as C. antarctica lipase (e.g., C. antarctica lipase A or B) (see, e.g., EP 214761), Pseudomonas lipases such as P. alcaligenes and P. pseudoalcaligenes lipase (see, e.g., EP 218272), P. cepacia lipase (see, e.g., EP 331376), P. stutzeri lipase (see, e.g., GB 1,372,034), P. fluorescens lipase, Bacillus lipase (e.g., B. subtilis lipase (Dartois et al., Biochem. Biophys. Acta 1131:253-260 (1993)), B. stearothermophilus lipase (see, e.g., JP 64/744992), and B. pumilus lipase (see, e.g., WO 91/16422)). Exemplary cloned lipases include, but not limited to Penicillium camembertii lipase (See, Yamaguchi et al., Gene 103:61-67 (1991)), Geotricum candidum lipase (See, Schimada et al., J. Biochem., 106:383-388 (1989)), and various Rhizopus lipases, such as, R. delemar lipase (See, Hass et al., Gene 109:117-113 (1991)), R. niveus lipase (Kugimiya et al., Biosci. Biotech. Biochem. 56:716-719 (1992)) and R. oryzae lipase. Other lipolytic enzymes, such as cutinases, may also find use in one or more composition describe herein, including, but not limited to, e.g., cutinase derived from Pseudomonas mendocina (see, WO 88/09367) and/or Fusarium solani pisi (see, WO90/09446). Exemplary commercial lipases include, but are not limited to M1 LIPASE™, LUMA FAST™, LIPOMAX™ and PREFERENZ® L (DuPont); LIPEX®, LIPOCLEAN®, LIPOLASE® and LIPOLASE® ULTRA (Novozymes); and LIPASE P™ (Amano Pharmaceutical Co. Ltd).

A still further embodiment is directed to a composition comprising one or more inherently stable subtilisin variant and one or more amylase. In one embodiment, the composition comprises from about 0.00001% to about 10%, about 0.0001% to about 10%, about 0.001% to about 5%, about 0.001% to about 2%, or about 0.005% to about 0.5% amylase by weight composition. In other embodiments, the composition comprises from about 50 ppm to 500 ppm, or between 150 ppm to about 300 ppm, preferably about 250 ppm of amylase in the composition. Any amylase (e.g., alpha and/or beta) suitable for use in alkaline solutions may be useful to include in such composition. An exemplary amylase can be a chemically or genetically modified mutant. Exemplary amylases include, but are not limited to those of bacterial or fungal origin, such as, for example, amylases described in GB 1,296,839, WO9100353, WO9402597, WO94183314, WO9510603, WO9526397, WO9535382, WO9605295, WO9623873, WO9623874, WO 9630481, WO9710342, WO9741213, WO9743424, WO9813481, WO 9826078, WO9902702, WO 9909183, WO9919467, WO9923211, WO9929876, WO9942567, WO 9943793, WO9943794, WO 9946399, WO0029560, WO0060058, WO0060059, WO0060060, WO 0114532, WO0134784, WO 0164852, WO0166712, WO0188107, WO0196537, WO02092797, WO 0210355, WO0231124, WO 2004055178, WO2004113551, WO2005001064, WO2005003311, WO 2005018336, WO2005019443, WO2005066338, WO2006002643, WO2006012899, WO2006012902, WO2006031554, WO 2006063594, WO2006066594, WO2006066596, WO2006136161, WO 2008000825, WO2008088493, WO2008092919, WO2008101894, WO2008/112459, WO2009061380, WO2009061381, WO 2009100102, WO2009140504, WO2009149419, WO 2010/059413, WO 2010088447, WO2010091221, WO2010104675, WO2010115021, WO10115028, WO2010117511, WO 2011076123, WO2011076897, WO2011080352, WO2011080353, WO 2011080354, WO2011082425, WO2011082429, WO 2011087836, WO2011098531, WO2013063460, WO2013184577, WO 2014099523, WO2014164777, and WO2015077126. Exemplary commercial amylases include, but are not limited to AMPLIFY®, DURAMYL®, TERMAMYL®, FUNGAMYL®, STAINZYME®, STAINZYME PLUS®, STAINZYME PLUS®, STAINZYME ULTRA® EVITY®, and BAN™ (Novozymes); EFFECTENZ™ S 1000, POWERASE™, PREFERENZ™ S 100, PREFERENZ™ S 110, PREFERENZ® S 210, EXCELLENZ™ S 2000, RAPIDASE® and MAXAMYL® P (DuPont).

Yet a still further embodiment is directed to a composition comprising one or more inherently stable subtilisin variant and one or more cellulase. In one embodiment, the composition comprises from about 0.00001% to about 10%, 0.0001% to about 10%, about 0.001% to about 5%, about 0.001% to about 2%, or about 0.005% to about 0.5% cellulase by weight of composition. In other embodiments, the composition comprises from about 50 ppm to 500 ppm, or between 200 ppm to about 400 ppm, preferably about 350 ppm of cellulase in the composition. Any suitable cellulase may find use in a composition described herein. An exemplary cellulase can be a chemically or genetically modified mutant. Exemplary cellulases include but are not limited, to those of bacterial or fungal origin, such as, for example, is described in WO2005054475, WO2005056787, U.S. Pat. Nos. 7,449,318, 7,833,773, 4,435,307; EP 0495257; and U.S. Provisional Appl. No. 62/296,678. Exemplary commercial cellulases include, but are not limited to, CELLUCLEAN®, CELLUZYIVIIE®, CAREZYME®, ENDOLASE®, RENOZYME®, and CAREZYME® PREMIUM (Novozymes); REVITALENZ™ 100, REVITALENZ™ 200/220, and REVITALENZ® 2000 (DuPont); and KAC-500(B)™ (Kao Corporation). In some embodiments, cellulases are incorporated as portions or fragments of mature wild-type or variant cellulases, wherein a portion of the N-terminus is deleted (see, e.g., U.S. Pat. No. 5,874,276).

An even still further embodiment is directed to a composition comprising one or more inherently stable subtilisin variant and one or more mannanase. In one embodiment, the composition comprises from about 0.00001% to about 10%, about 0.0001% to about 10%, about 0.001% to about 5%, about 0.001% to about 2%, or about 0.005% to about 0.5% mannanase by weight composition. In other embodiments, the composition comprises from about 50 ppm to 500 ppm, or between 100 ppm to about 250 ppm, preferably about 110 ppm of mannanase in the composition. An exemplary mannanase can be a chemically or genetically modified mutant. Exemplary mannanases include, but are not limited to, those of bacterial or fungal origin, such as, for example, as is described in WO 2016/007929; U.S. Pat. Nos. 6,566,114; 6,602,842; and 6,440,991: and U.S. Provisional Appl. Nos. 62/251516, 62/278383, and 62/278387. Exemplary commercial mannanases include, but are not limited to MANNAWAY® (Novozymes) and EFFECTENZ™ M 1000, PREFERENZ® M 100, MANNASTAR®, and PURABRITE™ (DuPont).

A yet even still further embodiment is directed to a composition comprising one or more inherently stable subtilisin variant and one or more peroxidase and/or oxidase enzyme. In one embodiment, the composition comprises from about 0.00001% to about 10%, about 0.0001% to about 10%, about 0.001% to about 5%, about 0.001% to about 2%, or about 0.005% to about 0.5% peroxidase or oxidase by weight composition. In other embodiments, the composition comprises from about 50 ppm to 500 ppm, or between 100 ppm to about 250 ppm, preferably about 130 ppm of peroxidase or oxidase in the composition. A peroxidase may be used in combination with hydrogen peroxide or a source thereof (e.g., a percarbonate, perborate or persulfate) and an oxidase may be used in combination with oxygen. Peroxidases and oxidases are used for “solution bleaching” (i.e., to prevent transfer of a textile dye from a dyed fabric to another fabric when the fabrics are washed together in a wash liquor), alone or in combination with an enhancing agent (see, e.g., WO94/12621 and WO95/01426). An exemplary peroxidase and/or oxidase can be a chemically or genetically modified mutant. Exemplary peroxidases/oxidases include, but are not limited to those of plant, bacterial, or fungal origin.

Another embodiment is directed to a composition comprising one or more inherently stable subtilisin variant, and one or more perhydrolase, such as, for example, is described in WO2005/056782, WO2007/106293, WO 2008/063400, WO2008/106214, and WO2008/106215.

A still further embodiment is directed to a composition comprising one or more inherently stable subtilisin variant and one or more deoxyribonuclease (DNase). In one embodiment, the composition comprises from about 0.00001% to about 10%, about 0.0001% to about 10%, about 0.001% to about 5%, about 0.001% to about 2%, or about 0.005% to about 0.5% DNase by weight composition. In other embodiments, the composition comprises from about 50 ppm to 500 ppm, or between 100 ppm to about 250 ppm, preferably about 130 ppm of deoxyribonuclease in the composition. Any DNase suitable for use in alkaline solutions may be useful to include in such composition. Any DNase can be a chemically or genetically modified mutant. Exemplary DNase include, but are not limited to those of bacterial or fungal origin, such as, for example, a DNase which is obtainable from a Bacillus species; in particular a DNase which is obtainable from Bacillus subtilis or Bacillus licheniformis. Examples of such DNases are described in WO 2011098579, WO2017059802, or in WO2014087011.

In some embodiments, the compositions provided herein comprise substantially no enzyme stabilizer, preferably, no enzyme stabilizer. In some embodiments, the compositions comprise less than about 0.5% by weight of the total detergent composition of a protease stabilizer, less than about 0.4%, 0.3%, 0.2%, 0.1%, 0.05%, or 0.01% by weight of the total detergent composition of a protease stabilizer.

In some embodiments, the composition provided herein comprises substantially no, or no, inorganic enzyme stabilizer. In some embodiments, the compositions contain substantially no, or no, enzyme stabilizer that is a water-soluble source of calcium and/or magnesium ions. In some embodiments, enzyme stabilizers include oligosaccharides, polysaccharides, and inorganic divalent metal salts, including alkaline earth metals, such as calcium salts. In some embodiments, the enzymes are not stabilized by the presence of water-soluble sources of zinc (II), calcium (II) and/or magnesium (II) ions in the finished compositions that provide such ions to the enzymes, as well as other metal ions (e.g., barium (II), scandium (II), iron (II), manganese (II), aluminum (III), tin (II), cobalt (II), copper (II), nickel (II), and oxovanadium (IV)). Chlorides and sulfates also find use in some embodiments. Exemplary oligosaccharides and polysaccharides (e.g., dextrins) are described, for example, in WO 07/145964.

In some embodiments, the compositions provided herein comprise substantially no, or no, reversible protease inhibitors, such as boron-containing compounds (e.g., borate, 4-formyl phenyl boronic acid, and phenyl-boronic acid derivatives (such for example, those described in WO96/41859) and/or a peptide aldehyde, such as, for example, is further described in WO2009/118375 and WO2013004636.

In other embodiments, the one or more compositions provided herein does not contain an enzyme stabilizer or peptide inhibitor, or contains a reduced amount of an enzyme stabilizer and peptide inhibitors, such as peptide aldehydes or a phenyl boronic acid, or a derivative thereof. That is, the subtilisin variants used in the compositions provided herein have an increased stability with respect to a reference subtilisin in compositions that lack an enzyme stabilizer or peptide inhibitors, or contain a reduced amount of an enzyme stabilizer or peptide inhibitor.

Peptide aldehydes have been used as protease stabilizers in detergent formulations as previously described (WO199813458, WO2011036153, US20140228274). Examples of peptide aldehyde stabilizers are peptide aldehydes, ketones, or halomethyl ketones and might be ‘N-capped’ with for instance a ureido, a carbamate, or a urea moiety, or ‘doubly N-capped’ with for instance a carbonyl, a ureido, an oxiamide, a thioureido, a dithiooxamide, or a thiooxamide moiety (EP2358857B1). Other examples of protease stabilizers are benzophenone or benzoic acid anilide derivatives, which might contain carboxyl groups (U.S. Pat. No. 7,968,508 B2).

Protease stabilizers typically include those selected from the group consisting of potassium salts of halides, sulfates, sulfites, carbonates, hydrogencarbonates, nitrates, nitrites, phosphates, formates, acetates, propionates, citrates, maleates, tartarates, succinates, oxalates, lactates, and mixtures thereof, preferably selected from the group consisting of potassium chloride, potassium sulfate, potassium acetate, potassium formate, potassium propionate, potassium lactate and mixtures thereof, more preferably potassium, acetate, potassium chloride and mixtures thereof, most preferably potassium acetate.

In some particular embodiments, the compositions comprise no, or substantially no enzyme stabilizers, such as proteases inhibitors, for example a peptide aldehyde or ketone, or a hydrosulfite adduct thereof; or a phenyl boronic acid, or a derivative thereof.

The medical and dental cleaning compositions provided herein may further contain one or more additional detergent components, such as bleaching systems, a chelating agent, an alkanolamine, a corrosion inhibitor, a sequestrant, a builder, a defoaming agent, a preservative, dye, fragrance, water, and mixtures thereof.

In some embodiments, one or more composition described herein comprises one or more bleach, bleach activator, and/or bleach catalyst. In some embodiments, one or more composition described herein comprises one or more inorganic and/or organic bleaching compound. Exemplary inorganic bleaches include, but are not limited to perhydrate salts, e.g., perborate, percarbonate, perphosphate, persulfate, and persilicate salts. In some embodiments, inorganic perhydrate salts are alkali metal salts. In some embodiments, inorganic perhydrate salts are included as the crystalline solid, without additional protection, although in some other embodiments, the salt is coated. Bleach activators are typically organic peracid precursors that enhance the bleaching action in the course of cleaning at temperatures of 60° C. and below. Exemplary bleach activators include compounds which, under perhydrolysis conditions, give aliphatic peroxoycarboxylic acids having from about 1 to about 10 carbon atoms or about 2 to about 4 carbon atoms, and/or optionally substituted perbenzoic acid. Exemplary bleach activators are described, for example, in EP 2100949. Exemplary bleach catalysts include, but are not limited to, manganese triazacyclononane and related complexes, as well as cobalt, copper, manganese, and iron complexes. Additional exemplary bleach catalysts are described, for example, in U.S. Pat. Nos. 4,246,612; 5,227,084; 4,810,410; WO 99/06521; and EP 2100949.

In some embodiments, one or more composition described herein comprises one or more catalytic metal complexes. In some embodiments, a metal-containing bleach catalyst finds use. In some embodiments, the metal bleach catalyst comprises a catalyst system comprising a transition metal cation of defined bleach catalytic activity (e.g., copper, iron, titanium, ruthenium, tungsten, molybdenum, or manganese cations), an auxiliary metal cation having little or no bleach catalytic activity (e.g., zinc or aluminum cations), and a sequestrate having defined stability constants for the catalytic and auxiliary metal cations, particularly ethylenediaminetetraacetic acid, ethylenediaminetetra (methylenephosphonic acid) and water-soluble salts thereof (see, e.g., U.S. Pat. No. 4,430,243). In some embodiments, one or more composition described herein is catalyzed by means of a manganese compound. Such compounds and levels of use are described, for example, in U.S. Pat. No. 5,576,282. In additional embodiments, cobalt bleach catalysts find use and are included in one or more composition described herein. Various cobalt bleach catalysts are described, for example, in U.S. Pat. Nos. 5,597,936 and 5,595,967.

In some additional embodiments, one or more composition described herein includes a transition metal complex of a macropolycyclic rigid ligand (MRL). As a practical matter, and not by way of limitation, in some embodiments, the compositions and cleaning processes described herein are adjusted to provide on the order of at least one part per hundred million, from about 0.005 ppm to about 25 ppm, about 0.05 ppm to about 10 ppm, or about 0.1 ppm to about 5 ppm of active MRL in the wash liquor. Exemplary MRLs include, but are not limited to special ultra-rigid ligands that are cross-bridged, such as, e.g., 5,12-diethyl-1,5,8,12-tetraazabicyclo(6.6.2)hexadecane. Exemplary metal MRLs are described, for example, in WO 2000/32601 and U.S. Pat. No. 6,225,464.

In another embodiment, one or more composition described herein comprises one or more metal care agent. In some embodiments, the composition comprises from about 0.1% to about 5% metal care agent by weight composition. Exemplary metal care agents include, for example, aluminum, stainless steel, and non-ferrous metals (e.g., silver and copper). Additional exemplary metal care agents are described, for example, in EP 2100949, WO 94/26860, and WO 94/26859. In some compositions, the metal care agent is a zinc salt.

### Cleaning Methods

Also provided herein are methods for cleaning a medical or dental instrument. In one embodiment, the methods comprise contacting a medical or dental instrument in a detergent for medical or dental instrument cleaning where the composition comprises between about 1% to 15% by weight of a nonionic surfactant; between about 0.5% to 15% by weight of an inherently stable subtilisin variant; and where the composition does not comprise a substantial amount of a enzyme stabilizer; allowing the instrument to be contacted for a period of time sufficient to reduce or remove soils on the instrument; and optionally rinsing the instrument.

In another embodiment, the methods comprise contacting a medical or dental instrument in a detergent for medical or dental instrument cleaning where the composition comprises between about 1% to about 15% by weight of the total composition of a nonionic surfactant, between about 250 to about 10000 ppm of an inherently stable subtilisin variant and substantially no protease stabilizer.

In another embodiment, the methods comprise soaking a medical or dental instrument in a detergent for medical or dental instrument cleaning where the composition comprises between about 1% to 15% by weight of a nonionic surfactant; between about 0.5% to 15% by weight of an inherently stable subtilisin variant; and where the composition does not comprise a substantial amount of a enzyme stabilizer; soaking the instrument for a period of time sufficient to reduce or remove soils on the instrument; and optionally rinsing the instrument.

In yet another embodiment, the methods comprise soaking a medical or dental instrument in a detergent for medical or dental instrument cleaning where the composition comprises between about 1% to 15% by weight of a nonionic surfactant; between about 250 to about 10000 ppm of an inherently stable subtilisin variant; and where the composition does not comprise a substantial amount of an enzyme stabilizer

The methods provided herein can be conducted under a range of temperature conditions, for example, between room temperature and about 90° C., preferably between about 20° C. and about 90° C., more preferable between about 30° C. and about 80° C., between about 30° C. and about 70° C., or between about 40° C. and about 60° C. Soaking of the medical and dental instruments may be carried out with or without mechanical action (such as shaking or stirring) in a tray, tub, pan, or sink; or by spraying such as through an instrument washer; by ultrasonic treatment, treatment in a cart or cage washer; by manually applying it with a hand-held bottle as either a spray or a foam; or by mechanized washing in a laboratory glass machine washer.

The contacting or soaking steps of the methods provided herein may be conducted for any amount of time needed to cleaning the medical or dental instrument. In some embodiments, the contacting or soaking steps are conducted for at least 1 minute. In another embodiment, the contacting or soaking step is conducted for between about 1 minute and about 60 minutes. In still other embodiments, the contacting or soaking steps are conducted for up to 24 hours, or between 1 minute and 24 hours.

The methods provided herein are generally conducted under neutral to alkaline conditions. In one embodiment, the methods are carried out in a pH of between about 7 to about 10.

As used herein, “soaking” refers to wetting the medical and dental instruments with the composition, or to immerse, or partly immerse, such instruments in the cleaning composition for a period of time, or a. combination of both. A medical or dental instrument may be only partly soaked with the cleaning composition if only a part of the instrument needs cleaning. For example, it may be desirable to avoid contacting electronic circuits or other electrical parts with the aqueous cleaning composition.

In some embodiments, the medical and dental instruments are rinsed, for example with water, after the contacting or soaking the medical or dental instrument in the compositions provided herein.

The methods provided herein are capable of removing all, or nearly all, of the soils degradable by proteases, such as, blood, blood constituents, blood proteins, fibrin, albumin and/or hemoglobin.

The medical and dental instruments that may be cleaned, washed, and/or soaked using the compositions provided herein, include medical and dental devices, instruments, or equipment, including any of the various medical or dental instruments or devices that can benefit from cleaning with the enzyme cleaning composition. In one embodiment, the medical and dental instruments include, for example, instruments, devices, tools, appliances, apparatus, and equipment used in medicine or dentistry, including those than can be cold sterilized, soaked or washed and then heat sterilized, or otherwise benefit from cleaning in the disclosed compositions. These various instruments, devices and equipment include, but are not limited to: diagnostic instruments, trays, pans, holders, racks, forceps, scissors, shears, saws (e.g. bone saws and their blades), hemostats, knives, chisels, rongeurs, files, nippers, drills, drill bits, rasps, burrs, spreaders, breakers, elevators, clamps, needle holders, carriers, clips, hooks, gouges, curettes, retractors, straightener, punches, extractors, scoops, keratomes, spatulas, expressors, trocars, dilators, cages, glassware, tubing, catheters, cannulas, plugs, stents, endoscopes, arthoscopes and related equipment, and the like, or combinations thereof,

The following examples are provided to demonstrate and illustrate certain preferred embodiments and aspects of the present disclosure and should not be construed as limiting.

### EXAMPLES

### Example 1

### Method for Establishing Washing Performance Using TOSI Cleaning Indicator

The TOSI cleaning indicator is a blood soil comprising a mixture of different sources of protein applied on stainless steel. The stainless-steel coupon is placed in a see-through plastic holder and submerged into a beaker with a wash solution. The beaker is placed in a water bath at 50° C. and stirred at 300 rpm for 20 minutes. The pH of the wash solution was determined by the detergent formula used.

The cleaning performance was determined by using multispectral image acquisition using a VideometerLab4 (Videometer A/S, Hørsholm, Denmark). The imaging software allows to calculate the surface area of the blood soil that is still present on the stainless-steel surface, and compare to the initial surface before washing.

A commercially available detergent for medical instrument cleaning containing protease, Prolystica 2X Concentrate Enzymatic (ex. Steris), was purchased to evaluate the washing performance according to above mentioned methodology. Part of the detergent was incubated at 90° C. for 20 minutes to inactivate the protease; after cooling down to ambient temperature three (3) different proteases were dosed at equal inclusion level.

The washing performance on a TOSI cleaning indicator is summarized in below table. The detergent was dosed at 1 g/L.

| | Soil |
|---|---|
| Detergent | removal |
| Prolystica 2X Concentrate Enzymatic | 75% |
| ex Steris | |
| Steris detergent (inactivated) − no protease | 8.8% |
| Steris detergent (inactivated) + 0.1 g/L | 94% |
| Commercial protease 1) | |
| Steris detergent (inactivated) + 0.1 g/L | 84% |
| Commercial protease with stabilizer 2) | |
| Steris detergent (inactivated) + 0.1 g/L | 81% |
| stable protease variant 1 3) | |

1) PREFERENZ ® P 200
2) Liquanase Evens 900L (ex. Novozymes)
3) Subtilisin variant 1 (SQCBV419, WO2017210295)

The percentage of soil removal (Soil removal %) is defined as the surface area after washing divided by the initial surface area. Each experiment was run in duplicate. The measurement data show that all three proteases in this study meet or exceed the washing performance of the commercial product at 0.1 g/L. Only a low level of soil removal is obtained by the inactivated detergent sample without protease.

### Example 2

### Compositions for Medical Instrument Cleaning Detergent and Protease Biochemical Stability

| Ingredients | Formula A | Formula B |
|---|---|---|
| C12-14 Alcohol Ethoxylate, 9EO | 8 | 2 |
| Mono propylene glycol | 5 | 20 |
| Glycerol | 10 | 10 |
| Ethanolamine | 1 | 1 |
| Sodium citrate | 3 | 3 |
| CMIT/MIT 1) | 0.01 | 0.01 |
| Protease 2) | 2000 ppm | 2000 ppm |
| Amylase 3) | 250 ppm | 250 ppm |
| Lipase 4) | 1200 ppm | 1200 ppm |
| Water | Balance | Balance |
| pH | 7.8-8.0 | 7.8-8.0 |

Inclusion level is given “as is” in weight % except for enzymes (active enzyme protein in ppm)
1) Kathon LX 150 ex DOW
2) Subtilisin variant 1 (SQCBV419, WO2017210295)
3) PREFERENZ ® S210
4) PREFERENZ ® L 100

The residual protease activity was tested by measuring the hydrolysis of N-suc-AAPF-pNA substrate (or AAPF method as described in WO2017210295) after incubation of the detergent sample for 2 & 4 weeks at 37° C. The residual protease activity was divided by the initial activity and expressed in percentage.

| | Formula A | | Formula B | |
|---|---|---|---|---|
| | T = 2 | T = 4 | T = 2 | T = 4 |
| | weeks | weeks | weeks | weeks |
| Standard protease 1) | 19% | 8% | 50% | 30% |
| Protease with stabilizer 2) | 85% | 75% | 84% | 74% |
| Stable protease variant 1 3) | 80% | 60% | 97% | 92% |
| Stable protease variant 2 4) | 90% | 75% | 90% | 89% |
| Stable protease variant 3 5) | 59% | 41% | 88% | 83% |

1) PREFERENZ ® P 200
2) Liquanase Evens 900L ( Novozymes)
3) Subtilisin variant 1 (SQCBV419, WO2017210295)
4) Subtilisin variant 2 (Blcarl 07865, U.S. Provisional Application 62/591976, filed Nov. 29, 2017)
5) Subtilisin variant 3 (SQCBV35, WO2017210295)

The data demonstrate that a commercial protease has low residual activity when stored for 4 weeks storage at 37° C. due to the absence of a protease stabilizer, particularly when dosed in Formula A. Using a commercial protease with a peptide aldehyde stabilizer a residual stability of 75% or 74%, respectively, can be achieved. For Formula A, stable protease variant 2 can achieve the same stability profile, while each stable protease variant can retain even more stability in Formula B in the absence of a protease stabilizer.

Although the disclosure has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present disclosure. To the extent that section headings are used, they should not be construed as necessarily limiting.

What is claimed is:

1. A medical or dental instrument detergent composition comprising:
between about 1% to 15% by weight of a nonionic surfactant;
between about 250 ppm and about 10000 ppm of an inherently stable subtilisin variant
wherein the composition does not comprise a substantial amount of a protease stabilizer.

2. The detergent composition of claim 1, wherein the composition comprises less than about 0.01% by weight, of a protease stabilizer.

3. The detergent composition of claim 2, wherein the composition comprises less than about 0.001% by weight of a protease stabilizer.

4. The detergent composition of claim 1, wherein the composition does not comprise a protease stabilizer selected from the group consisting of a protease inhibitor, peptide aldehyde, an organoboron compound, or boronic acid derivative.

5. The detergent composition of claim 4, wherein the boronic acid derivative is phenyl boronic acid (PBA) or 4-formylphenyl-boronic acid (FPBA).

6. The detergent composition of claim 1, wherein the nonionic surfactant is a C₆ to C₂₀ alcohol ethoxylate with 2 to 14 moles of ethoxylation.

7. The detergent composition of claim 6, wherein the nonionic surfactant is selected from the group of polyoxyalkylene alkyl ethers, polyalkylene glycols, alkylamine oxides, polyoxyalkylene, alkyl phenyl ethers, fatty acid polyoxyethylene esters, fatty acid sorbitan esters, fatty acids polyoxyalkylene sorbitan esters, fatty acid saccharide esters, alkyl polysaccharides, alkyl glyceryl ethers, and fatty acid alkanolamides.

8. The detergent composition of claim 1, wherein the composition further comprises between about 10-30% by weight of at least one organic solvent.

9. The detergent composition of claim 8, wherein the solvent is selected from the group consisting of polyols such as glycerol, propane-1,2-diol or propane-1,3-diol.

10. The detergent composition of claim 1, wherein the composition further comprises, from about 10% to 30% by weight of a biodegradable chelating agent.

11. The detergent composition of claim 11, wherein the biodegradable chelating agent is selected from the group of sodium salts of glutamic acid diacetic acid (GLDA), methylglycinediacetic acid (MGDA), and itaconic acid.

12. A method for cleaning a medical or dental instrument comprising:
a) contacting the medical or dental instrument in a detergent for medical or dental instrument cleaning comprising between about 1% to 15% by weight of a nonionic surfactant;
between about 250 ppm and about 10000 ppm of an inherently stable subtilisin variant; wherein the composition does not comprise a substantial amount of a protease stabilizer;
b) allowing the instrument to be contacted for a period of time sufficient to reduce or remove soils on the instrument; and
c) optionally rinsing the instrument.

13. The method of claim 12, wherein the instrument is contacted with the detergent for at least 1 minute.

14. The method of claim 13, wherein the instrument is contact with the detergent for an amount of time up to 24 hours.

15. The method of claim 12, wherein the instrument is contacted with the detergent for between a time of 1-60 minutes?

16. The method of claim 12, wherein the instrument is contacted with the detergent at a temperature between 30 degrees and 70 degrees Celsius.

17. The method of claim 16, wherein the instrument is contacted with the detergent at a temperature between 40 degrees and 60 degrees Celsius.

18. The method of claim 12, wherein the composition comprises less than about 0.01% by weight, of a protease stabilizer.

19. The method of claim 18, wherein the composition comprises less than about 0.001% by weight, of a protease stabilizer.

20. The method of claim 12, wherein the composition does not comprise a protease stabilizer selected from the group consisting of a peptide aldehyde, organoboronic acid, or boronic derivative.

21. The method of claim 20, wherein the boronic acid derivative is phenyl boronic acid (PBA) or 4-formylphenyl-boronic acid (4-FPBA).

22. The method of claim 12, wherein the nonionic surfactant is a C6 to C20 alcohol ethoxylate with 2 to 14 moles of ethoxylation.

23. The method of claim 22, wherein the nonionic surfactant is selected from the group of polyoxyalkylene alkyl ethers, polyalkylene glycols, alkylamine oxides, polyoxyalkylene alkyl phenyl ethers, fatty acid polyoxyethylene esters, fatty acid sorbitan esters, fatty acids polyoxyalkylene sorbitan esters, fatty acid saccharide esters, alkyl polysaccharides, alkyl glyceryl ethers, and fatty acid alkanolamides. an alcohol ethoxylate.

24. The method of claim 12, wherein the composition further comprises between about 10-30% by weight of at least one organic solvent.

25. The method of claim 24, wherein the solvent is selected from the group consisting of propylene glycol, glycerol, propane-1,2-diol or propane-1,3-diol.

26. The method of claim 12, wherein the composition further comprises, from about 10% to 30% by weight of a biodegradable chelating agent.

27. The detergent composition of claim 26, wherein the biodegradable chelating agent is selected from the group of sodium salts of glutamic acid diacetic acid (GLDA), methylglycinediacetic acid (MGDA), and itaconic acid.
